(19) United States
(12) Patent Application Publication
(10) Pub. No.: US 2008/0044209 A1
(43) Pub. Date: Feb. 21, 2008

(54) IMAGE FORMING APPARATUS

(75) Inventor: Takashi NAKANISHI, Abiko-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/762,453

(22) Filed: Jun. 13, 2007

(30) Foreign Application Priority Data
Jul. 7, 2006 (JP) 2006-187449

(51) Int. Cl. G03G 15/00

(52) U.S. Cl. 399/380

(57) ABSTRACT

An image forming apparatus which can eliminate an unnecessary digital process in a simple copying operation is provided.

In the image forming apparatus including a reading portion which irradiates light on an original to read original information, and an image forming portion which selectively exposes an image bearing member to form an electrostatic latent image and develops the electrostatic latent image to form an image, the reading portion has an original pressing plate which holds the original, and electronic paper placed on an original pressing surface side of the pressing plate to make it possible to display image data sent from an external device on the electronic paper.

### BACKGROUND OF THE INVENTION

1. Field of the Invention

The present invention relates to an image forming apparatus having a reading portion which irradiates light on an original to read original information and an image forming portion which selectively exposes an image bearing member to form an electrostatic latent image and develops the electrostatic latent image to form an image.

2. Description of Related Art

When an original is merely read to copy the information of the original, an analog scheme which irradiates light on the original to write the light reflected from the original on a drum is sufficient. However, in order to print electronic data such as printout data from a personal computer, a digital scheme which electrically writes light on a drum is necessary. In such a digital copying machine, a method using a laser or an LED as the writing device is generally performed.

In printing from a personal computer, in order to display a plurality of images on a preview screen on a CRT, a system which reduces and displays respective images in accordance with an image size and performs desired edition setting to one of the images to print the image or to sequentially and continuously display the images on the preview screen is proposed (see Japanese Patent Application Laid-Open No. 10-42087).

In order to easily check a desired image, an image output system which switches between an output to printer and an output to electronic paper on the basis of an amount of data of image data is proposed (see Japanese Patent Application Laid-Open No. 2003-140857).

However, in the conventional art, a digital copying machine requires a reading device such as a CCD and a light source such as a laser. For this reason, the digital copying machine is more expensive than an analog copying machine.

The present invention has as its object to provide an image forming apparatus which can eliminate unnecessary digital processing in simple copying operation.

It is another object of the present invention to provide an image forming apparatus which copes with print from a personal computer by using an inexpensive analog copying process.

It is still another object of the present invention to provide an image forming apparatus which can adjust an image position on the basis of a print instruction from an operation portion or an external I/F processing portion without waste printing such as misprint.

### SUMMARY OF THE INVENTION

A typical means in the present invention to solve the above problem relates to an image forming apparatus including a reading portion which irradiates light on an original to read original information and an image forming portion which selectively exposes an image bearing member to form an electrostatic latent image and develops the electrostatic latent image to form an image, wherein the reading portion has an original pressing member which holds the original and electronic paper arranged on an original pressing surface side of the original pressing member to make it possible to display image data sent from an external device on the electronic paper.

Information from an external device such as a personal computer is displayed, and light is irradiated on the information to read the information, so that the image information of the external device can be printed without digital processing. For this reason, the image forming apparatus can cope with printing from the external device by using an inexpensive analog copying process.

### BRIEF DESCRIPTION OF THE DRAWINGS

FIG. 1 is a sectional explanatory diagram of an image forming apparatus according to an embodiment of the present invention.

FIG. 2 is an explanatory diagram in case of normal copy.

FIG. 3 is a block diagram of an image processing portion.

FIG. 4 is an explanatory diagram illustrating a copy of an image shown on electronic paper.

### DETAILED DESCRIPTION OF THE PREFERRED EMBODIMENTS

An image forming apparatus according to an embodiment of the present invention will be concretely described below with reference to the drawings.

(Entire Configuration of Image Forming Apparatus)

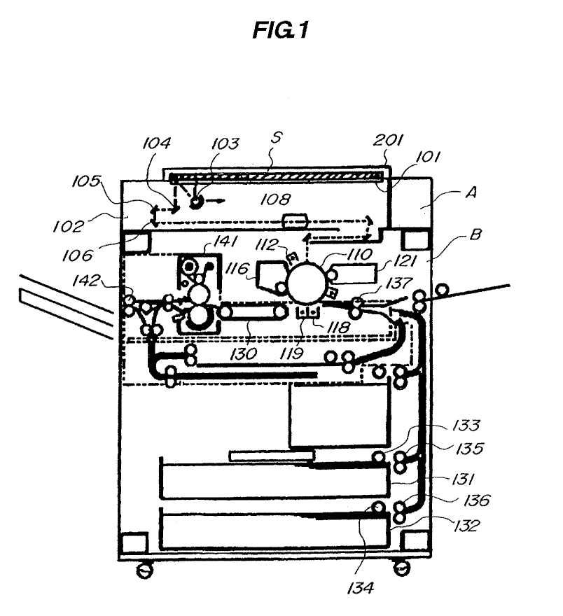

An entire configuration of an image forming apparatus will be concretely described together with an image forming operation with reference to FIG. 1.

FIG. 1 is a sectional explanatory diagram of an image forming apparatus according to an embodiment of the present invention. The image forming apparatus according to the embodiment, as shown in FIG. 1, has a reading portion A which irradiates light on an original to read original information, and an image forming portion B which selectively exposes a photosensitive drum serving as an image bearing member to form an electrostatic latent image and develops the electrostatic latent image with toner to form an image.

In the reading portion A, a platen glass 101 serving as an original placing table is attached to an upper surface of the apparatus main body, and an original is placed on the platen glass 101 to read original information by a scanner 102. Above the platen glass 101, a pressing plate 201 to hold the placed original is arranged. The pressing plate 201 is pivotally attached to the apparatus main body to make it possible to be opened or closed on the platen glass 101.

The scanner 102 includes original illuminating lamp 103 serving as a light source, a scanning mirror 104. The scanner 102 reciprocally scans in a predetermined direction by a motor (not shown). The scanner 102 irradiates light on the surface of the original placed on the platen glass 101 to focus the reflected light on a photosensitive drum 110 through scanning mirrors 104, 105, and 106 and a lens 108.

Around the photosensitive drum 110 constituting the image forming portion B, a primary charger 112, a development device 121, transfer chargers 118 and 119, and a cleaning device 116 are provided to constitute an image forming portion of an electrophotographic system. In the image forming portion B, the photosensitive drum 110 is rotated by a motor (not shown) and electrically charged to a desired potential by the primary charger 112. Thereafter, light is irradiated on the photosensitive drum 110 by the original illuminating lamp 103 to form an electrostatic latent image by reflected light reflected by the original. The electrostatic latent image formed on the photosensitive drum 110 is developed by the development device 121 to be made visual as a toner image.

On the other hand, a sheet P fed from an upper cassette 131 or a lower cassette 132 by the pickup rollers 133 and 134 is set to the image forming portion B by feeding rollers 135 and 136. The sheet P is fed to a transfer belt 130 by a resist roller 137, and the visualized toner image is transferred to the sheet P by the transfer charger 118. After the transfer, residual toner on the photosensitive drum 110 is cleaned up by the cleaning device 116 to eliminate residual electric charges.

The sheet P on which the toner image is transferred is separated from the transfer belt 130 and sent to a fixing device 141. The toner image is fixed by pressing and heating, and the sheet P is discharged out of the apparatus main body by a discharge roller 142.

(Configuration of Pressing Plate)

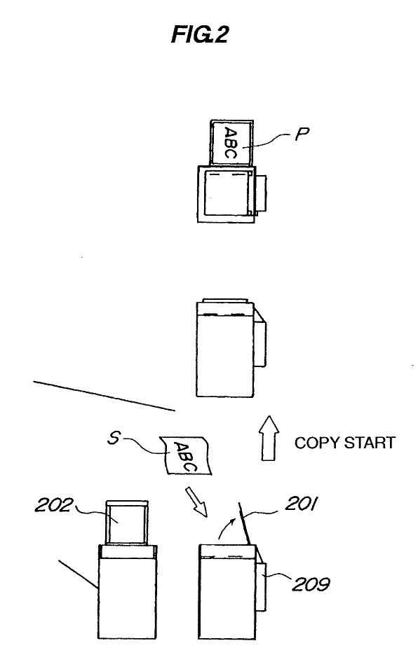

In the image forming apparatus, when a user performs a normal copying operation, as shown in FIG. 2, an original S is placed on the platen glass 101, and the original S is held by the pressing plate 201 serving as the original pressing member and set to start the copying operation.

On the pressing plate 201 of the embodiment, white electronic paper 202 is set on an original pressing surface side. The electronic paper 202 can display characters and graphics in black on a white background on the basis of an image signal to which predetermined image processing is performed.

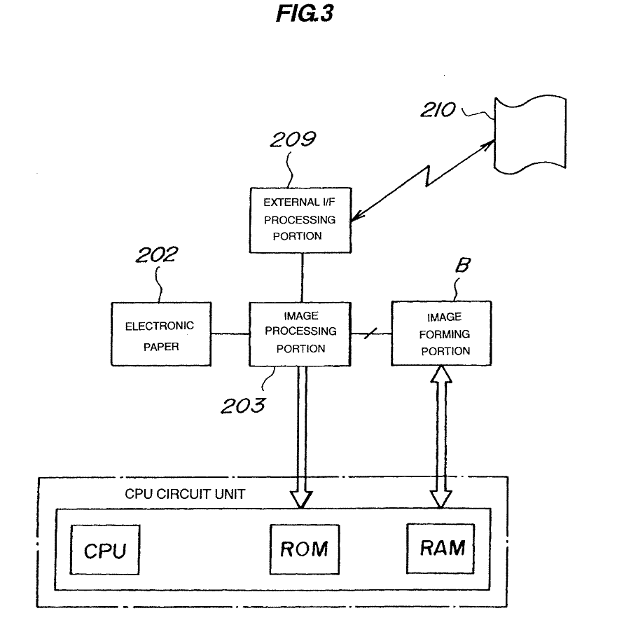

The image forming apparatus, as shown in FIG. 3, is able to transfer data 210 from an external device such as a personal computer through an external I/F 209 serving a communication unit.

The image can be displayed on the electronic paper 202.

More specifically, the external I/F 209 is connected to a image processing portion 203, expands image data input from an external computer or the like (not shown), and inputs the image data to the image processing portion 203. In the image processing portion 203, a correcting process such as γ correction required in an output system, a smoothing process, edge emphasis, other processing and processes are performed to the input image data. The data is output to the electronic paper 202 serving as an image output unit connected to the image processing portion 203.

The electronic paper 202 may perform monochrome display. However, as the electronic paper 202, electronic paper, for example, which displays characters by using an electrophoretic phenomenon in which particles move in a fluid called a carrier fluid sandwiched between two substrates is also applicable. This constitute a reflecting panel which changes states of charged particles in the fluid by changing positive/negative electric charges applied to the electrode to use scattered light of external incident light as a display. When an RGB color filter is combined to the reflective panel, full-color display can also be achieved. The electronic paper has both an advantage of flexible and movable paper and an advantage of a rewritable display.

In this embodiment, when image data is sent from an external device, data is output to a white microcapsule type electronic paper 202 to display an image. In this state, an operator opens the pressing plate 201 to make it possible to confirm whether the user wants to print the image transferred onto the electronic paper 202 arranged on the rear of the pressing plate 201.

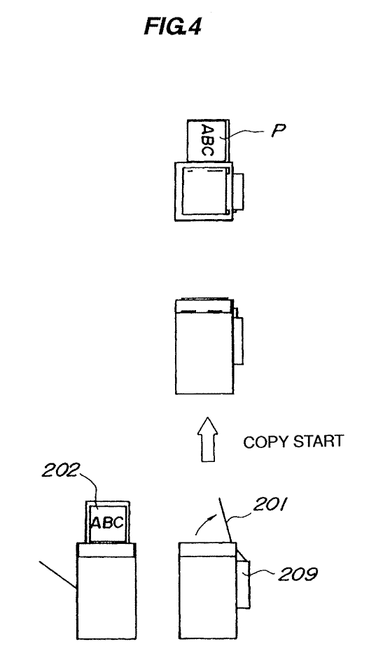

When it is confirmed that the user wants to print the data, as shown in FIG. 4, an operator closes the pressing plate 201 to start a copying operation. At this time, the original illuminating lamp 103 irradiates light on the electronic paper 202 to handle the electronic paper 202 as an original. Reflected light from the original illuminating lamp 103 exposes the photosensitive drum 110 to form an electrostatic latent image. In this manner, an image displayed on the electronic paper 202 is recorded on a conveyed sheet.

Therefore, even if exposure to the photosensitive drum 110 is an analog copying process, image formation is performed on the basis of data from an external device such as a personal computer.

The image forming apparatus according to the embodiment further includes a storage unit which stores image data input through the external I/F 209 and a setting unit which adjusts a display position or the like which is set when the input image data is displayed on the electronic paper 202.

On the other hand, when an image displayed when the pressing plate 201 is opened is erroneous, the operation transmits correct data again. Even if the displayed image is data the operation wants to print, when the operator adjust an image position (forward, backward, left, or right), the operator operates a position adjustment button (not shown) on the display unit to perform image position adjustment by the setting unit and closes the pressing plate 201 to start a copying operation. In addition, the setting unit may change magnification of the image data and rotate the image data before displaying the image data on the electronic paper.

In the image forming apparatus according to the embodiment, a normal copying operation in which an original is placed on the platen glass 101 to copy the original can also be performed. In this case, the electronic paper 202 is set to glow white. In this manner, the electronic paper 202 functions as a white plate which holds an original.

As described above, even in a copying machine in which an electrostatic latent image is formed by an inexpensive analog process, image data from an external device is temporarily displayed on electronic paper to make it possible to print an image.

Original information is previewed on the electronic paper 202 to eliminate waste such as misprint, and a print environment user-friendly print environment in which an image position can be easily adjusted is provided.

In the embodiment, a copying machine in which a latent image is formed by an analog process is illustrated. However, in a configuration in which original information is displayed on the electronic paper 202 to copy the original information as an original, a latent image is advantageously performed either by a digital copying machine or a digital multifunction imaging apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-187449 filed on Jul. 7, 2006 which is hereby incorporated by reference herein in its entirety.

What is claimed is:

1. An image forming apparatus comprising:
a reading portion which irradiates light on an original to read original information; and
an image forming portion which selectively exposes an image bearing member to form an electrostatic latent image and develops the electrostatic latent image to form an image, wherein
the reading portion has an original pressing member which holds the original, and electronic paper placed on an original pressing surface side of the original pressing member to make it possible to display image data sent from an external device on the electronic paper.

2. The image forming apparatus according to claim 1, further comprising:
a communication unit which inputs image data to an electronic paper;
a storing unit which stores the input image data; and
a setting unit which performs display adjustment of the input image data.

3. The image forming apparatus according to claim 2, wherein
the setting unit performs display adjustment to display the image data on the electronic paper while changing magnifications.

4. The image forming apparatus according to claim 2, wherein
the setting unit performs display adjustment to display the image data on the electronic paper while rotating the image data.

5. The image forming apparatus according to claim 1, wherein
original information is transmitted to the electronic paper, and the original information displayed on the electronic paper is read by the reading portion.

6. The image forming apparatus according to claim 1, wherein
the electronic paper glow white.

7. The image forming apparatus according to claim 1, wherein
the reading portion irradiates reflected light irradiated on one of the original and the electronic paper on the image bearing member.
